(19) United States
(12) Patent Application Publication
(10) Pub. No.: US 2021/0256519 A1
(43) Pub. Date: Aug. 19, 2021

(54) Computer architecture and method for single and consolidated real-time processing of event data in a complex computing network

(71) Applicant: Shaikh Abdulla Mohamed Khalid Ahmed Al Qasimi, Sharjah (AE)

(72) Inventors: Shaikh Abdulla Mohamed Khalid Ahmed Al Qasimi, Sharjah (AE); Tonye Warmate Anyanwu, Dubai (AE)

(21) Appl. No.: 17/175,232

(22) Filed: Feb. 12, 2021

Related U.S. Application Data
(60) Provisional application No. 62/976,159, filed on Feb. 13, 2020.

(51) Int. Cl. G06Q 20/40; G06Q 20/20; G06Q 20/38

(52) U.S. Cl. CPC G06Q 20/405; G06Q 20/207; G06Q 20/409; G06Q 20/389; G06Q 20/401

(57) ABSTRACT

A computer system for single and consolidated real-time processing of event data relating to VAT tax refunds requests. The system communicates with multiple retailer systems and multiple user devices in connection with the processing of that event data in accordance with an adaptive processing rules schema. The system includes a distributed system interface that receives the event data from the plurality of distributed retailer networks in the form of event data transactions. The system is operated in accordance with a rules schema database that contains tax models applicable to various event data transactions. An event data processor receives the event data transactions and applies the tax models in the rules schema database and is then operable through a payment gateway processor to direct electronic transactions to occur in responding to the processing of the event data based at least in part on rules stored in the rules schema database in communication with the event data processor. The computer system further includes a compliance system that is operable to communicate electronically with user devices to determine whether VAT refunds have been validly claimed and whether all conditions precedent and subsequent to the VAT refund request have been fulfilled.

### CROSS-REFERENCE TO RELATED APPLICATIONS

This application claims priority to U.S. Provisional Patent Application No. 62/976,159 filed on Feb. 13, 2020. The contents of the above application are hereby incorporated in its entirety by reference.

### BACKGROUND

Today, many national governments rely on various techniques and systems to attract and reward tourists and other visitors who visit their country. For instance, it has become commonplace for departments responsible for national travel and tourism to employ media advertising and websites which are optimized for use on mobile devices and which are made available to visitors across the globe to present unique characteristics of the country and incentives to attract those visitors. Other countries have instituted laws that give tourists and visitors preferential financial treatment.

For example, while many countries employ Value-Added Tax or “VAT” as a part of their revenue raising model, many of these same countries offer VAT-reimbursement on purchases made for export by allowing foreigners to acquire goods and/or services and paying the VAT at the point of purchase and then providing an opportunity for the foreigners to obtain a reimbursement of the VAT through a supplemental process or by waiving the VAT at the time of purchase. In the former case where a reimbursement is obtained on the VAT, the foreigners may be required to follow a supplemental process or visit an office of the national customs authority or an agent associated with the national customs authority prior to their departure to receive the VAT reimbursement.

Obtaining VAT reimbursements often presents a challenge to foreigners. One such challenge is that VAT reimbursements are reliant on the foreigner initiating the reimbursement process, which can be inconvenient because the foreigner would need to take time out of his/her vacation to complete the claims process. When the foreign visitor visits the relevant government agency, she/he may be required to complete a process that is not clearly defined or that may vary from one occasion to the next. Additionally, support for such a process may not be available in the native language of the foreign visitor. The foreign visitor may also encounter practical difficulties with securing the reimbursement depending on which options are available (e.g., the foreign visitor may have no payment card issued by an international card scheme, the foreign visitor's country may not operate a reliable postal system for check delivery, etc.). Moreover, VAT reimbursement processes are often painfully slow and error-prone due to the reliance on manual application handling and the need to analyze event data associated with a purchase to ensure that the purchase meets the VAT reimbursement requirements.

Additionally, the delays involved in processing reimbursement requests can be significant. Such delays may range on average from three days to an excess of one month. Due to the delay in the majority of cases, foreigners are unable to reuse such reimbursements while on their vacation, and accordingly the delays have a negative impact on the country in question by depriving its own economy of the benefit of additional revenue that could flow from visitors receiving (and spending) the reimbursed amounts. Other weaknesses in the current framework include visitors/foreigners often losing the supporting documentation vital to their claim, meaning that such visitors/foreigners may not have evidence of the time and date of their purchase which can lead to such visitors/foreigners being deprived from recovering the reimbursements they were entitled to. This can result in their frustration and can contribute to a negative attitude towards the country they just visited.

### SUMMARY

New systems, solutions, data structures and processes for real-time processing and transmission of event data associated with the reimbursement of VAT under a VAT-refund scheme are presented in this disclosure. Depending on their configuration, these systems, solutions, data structures and processes can allow the user (e.g., a non-tax resident visitor) to make purchases within a jurisdiction which is subject to VAT, submit a request for reimbursement of the VAT levied on the purchases, and receive a reimbursement in real-time or near-real-time. This gives the user ready and immediate or nearly immediate access to the reimbursed funds and offers them the opportunity to make further purchases in the VAT-reimbursed jurisdiction.

In order to use some solutions, the user does not need to keep hold of hardcopy documentation (e.g., receipts) to process the reimbursement request, because the information contained in the relevant paperwork may be captured and stored by one or more mobile devices or systems as described in the present disclosure.

In some cases, the reimbursement may be claimed on purchases that are intended to be exported from the country the purchaser is visiting. Accordingly, the visitor may be required, as part of the reimbursement process, to provide a proof-of-export for the purchases made in the VAT-reimbursed jurisdiction to indicate that the purchased items have indeed been taken out of the VAT-reimbursed jurisdiction.

The VAT levied on the purchases may include goods and service levies, value added tax, and/or consumption levies that residents in the jurisdiction in question are obliged to pay but from which foreigners are exempt. While for the purposes of this disclosure such consumption taxes are often referred to as “value-added taxes” or VAT, such characterization should not be construed to limit the generality of any levies or dues that may later benefit from the processes described in the present patent specification.

Because different jurisdictions have different policies for assessing amounts levied on purchases, rates for levies may range anywhere from 5% to 40% of the total purchase price depending on the jurisdiction. Thus, reimbursement of VAT within a VAT-reimbursed jurisdiction (VAT-reimbursed meaning VAT-reimbursed or VAT reimbursable to a particular non-tax resident visitor) can quickly become significant, especially for visitors who make large purchases while visiting the VAT-reimbursed jurisdiction.

### BRIEF DESCRIPTION OF THE DRAWINGS

The disclosure is illustrated by way of example, and is not intended to otherwise limit the applicability or generality of the figures of the accompanying drawings. In the accompanying drawings, like reference numerals are used to indicate similar elements. It is emphasized that various features may not be drawn to scale and the dimensions of various features may be arbitrarily increased or reduced for clarity of discussion.

FIG. 1 shows an exemplary complex network system for real-time processing and transmission of event data associated with reimbursements;

FIG. 2 illustrates a block diagram of an exemplary reimbursement workflow using the system of FIG. 1;

FIG. 3 illustrates a block diagram of an exemplary proof-of-export workflow based on the reimbursement workflow of FIG. 2;

FIG. 4 illustrates a block diagram of an exemplary cardless withdrawal workflow based on reimbursements generated from the reimbursement workflow of FIGS. 2; and

FIG. 5 illustrates a continuation of the cardless withdrawal workflow of FIG. 4.

These exemplary figures and embodiments are to provide a written, detailed description of the inventions set forth by any claims that issue from the present application. These exemplary figures and embodiments should not be used to limit any claims that ultimately issue in a patent from the present application.

### DETAILED DESCRIPTION

Reference will now be made to various embodiments, examples of which are illustrated in the accompanying drawings and figures. In the following detailed description, numerous specific details are set forth in order to provide a thorough understanding of this disclosure. However, it will be apparent to one of ordinary skill in the art that the disclosure may be practiced without these specific details. In some instances, well-known methods, processes, components, systems and networks have not been described in detail so as not to unnecessarily obscure aspects of the embodiments.

System Overview

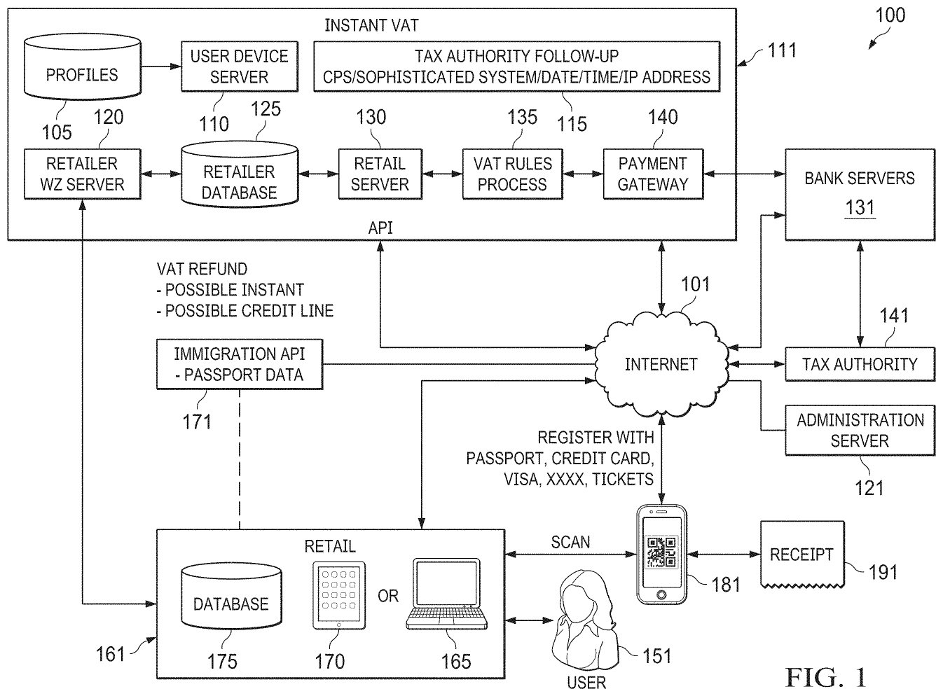

FIG. 1 shows an exemplary computer architecture and complex network system 100 for real-time processing and transmission of event data associated with reimbursements within a VAT-reimbursed jurisdiction. The broad elements of system 100 include a network 101 coupled to a backend server 111, an administration server 121, one or more bank servers 131, a government server or tax authority 141, a distributed plurality of retail systems or networks 161, an immigration system 171, and a user device 181. According to some implementations, a user 151 may interact with one or more elements of the retail system 161 independently or via the user device 181.

The backend server 111 includes a profiles database 105, a user device server 110, a tax authority rule compliance and follow-up system 115, a first retail wz server 120, a retailer database 125, a second retail server 130, a rules server 135, and a payment gateway server 140. According to one implementation, the profiles database 105 may be configured to store profile data in a certain known format for a user 151 and/or profile data of a retailer associated with the retail system 161. In one embodiment, profile data of a user 151 includes a name, a gender, an email address, credential information, nationality, date of birth, passport number, photograph (e.g., passport photograph), copy of passport, user signature, user ID number, biometric data, user device information, etc., of the user 151. Profile data of a retailer of the retail system 161 may include geolocation data, retailer name, retailer authentication credentials/protocols, retailer ID number, etc., in each case of the retailer associated with the retail system 161.

According to some implementations, the profiles database 105 may be communicatively coupled to the user device server 110 such that the user device server 110 processes user requests for registration and/or retailer requests for registration with the backend server 111. Processing a user or retailer request for registration may comprise analyzing user or retailer data (e.g., profile data), confirming user or retailer data with third party entities such as the authorities associated with the government or tax authority server 141, and validating, via the immigration system 171, etc., immigration data of the user 151 to confirm the taxing systems that apply to the user. In some implementations, processing a user or retailer request for registration may include storing new user data in the profiles database 105 or updating existing profile data in the profiles database 105.

According to one embodiment, the backend server 111 includes a retailer wz server 120, which can receive requests for processing, in real-time or near-real-time, multiple event data associated with reimbursements within a VAT-reimbursed jurisdiction. The event data may include transaction data associated with purchases made by tourists or visitors (e.g., non-tax resident foreigner) in a VAT-reimbursed jurisdiction. For example, transaction data may comprise time and date of purchase of an item, cost of the item, geolocation of the retail point of purchase, VAT levied on the purchased item, identifiers of the user (e.g., tourist or visitor) and the retailer, etc. According to one implementation, the retailer wz server 120 may process event data associated with reimbursements by extracting transaction data such as those discussed above and subsequently storing the extracted transaction data in the retailer database 125. A retail server 130 may retrieve and transmit extracted transaction data to a rules server 135, which can apply an adaptive rules schema whereby one or more rules may be applied to the extracted transaction data to generate a reimbursement amount for the user 151. According to one implementation, the adaptive rules schema may include jurisdiction-specific tariff information for computing reimbursements for foreigners within a VAT-reimbursed jurisdiction, jurisdiction-specific tariff information for classifying how much VAT levies should be reimbursed to non-tax resident foreigners, jurisdiction-specific information for classifying purchases by volume into tariff brackets and amounts to be reimbursed based on those brackets, etc. This rules schema is adaptable according to tax jurisdiction rules changes and can be flexibly adapted and rolled out through the secure computer architecture 11 described in the present application.

This new computer architecture allows for distributed access by multiple interested constituents in the process—end users, retailers, and government taxing authorities. The new computer architecture further provides for the reporting, analysis, and system improvements based upon the reporting and analysis of the federated information gathered from potentially millions or billions of transactions taking place between millions of users and thousands of retailers. This new computer architecture opens new opportunities to process millions or billions of transactions in real-time and securely process those millions or billions of transactions while at the same time continuously improving the process through Artificial Intelligence (AI), neural networks machine learning, or other architectures that can make use of the aggregated usage transaction and data and accompanying metadata. Further, by aggregating information on shopping activity, it may be possible for taxing authorities and merchants to improve selling processes and maximize revenues.

After the rules server 135 applies the one or more rules in order to compute a tariff reimbursement amount on a purchase by the user 151, a payment gateway server 140 may transmit payment data to one or more third parties such as one or more bank servers 131 to initiate payment of the reimbursement to the user 151. According to one implementation, one or more bank servers 131 may confirm the payment data with the government server or tax authority 141 for regulatory purposes (e.g., to confirm the reimbursement has been made) and await a request from the user via, for example, the user device 181, to retrieve the reimbursement. In some instances, one or more bank servers 131 may directly transmit to the user device 181 one or more of digital tokens, digital currencies, etc., indicative of payment of the reimbursement for redemption by the user 151. According to some embodiments, the user 151 may receive, from one or more bank servers 131, a visual indicator (e.g., an alert or notification) that a reimbursement associated with a VAT-reimbursed transaction has been credited to an account (e.g., digital wallet) belonging to the user 151. According to some implementations, the one or more bank servers 131 may provide the reimbursement to the user 151 after processing the transaction with rules and/or instructions provided to and from the government server or tax authority 141.

In some instances, the user may make a purchase at a given retail location and then subsequently scan a receipt 191 associated with the purchase using the user device 181 to generate a tariff reimbursement request in a retail system 161 associated with the retail location where the user made the purchase. Following the processing of the reimbursement request from the backend server 111 and the subsequent transmission of payment data to the one or more bank servers 131, the user 151 may receive, from the one or more bank servers 131 or the government server or tax authority 141, in real-time or near-real-time, an indication via the user device 181 that the reimbursement request has been successful and that the user has access to the reimbursed funds. This instantaneous reimbursement can further drive end user/customer satisfaction and additional sales within the merchant/country location.

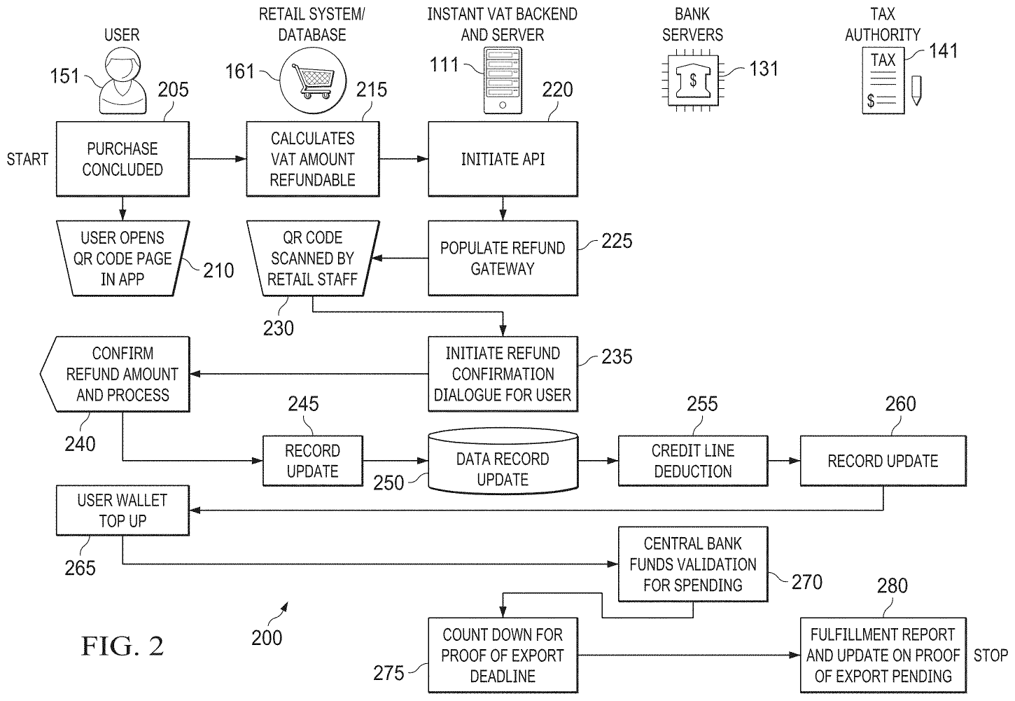

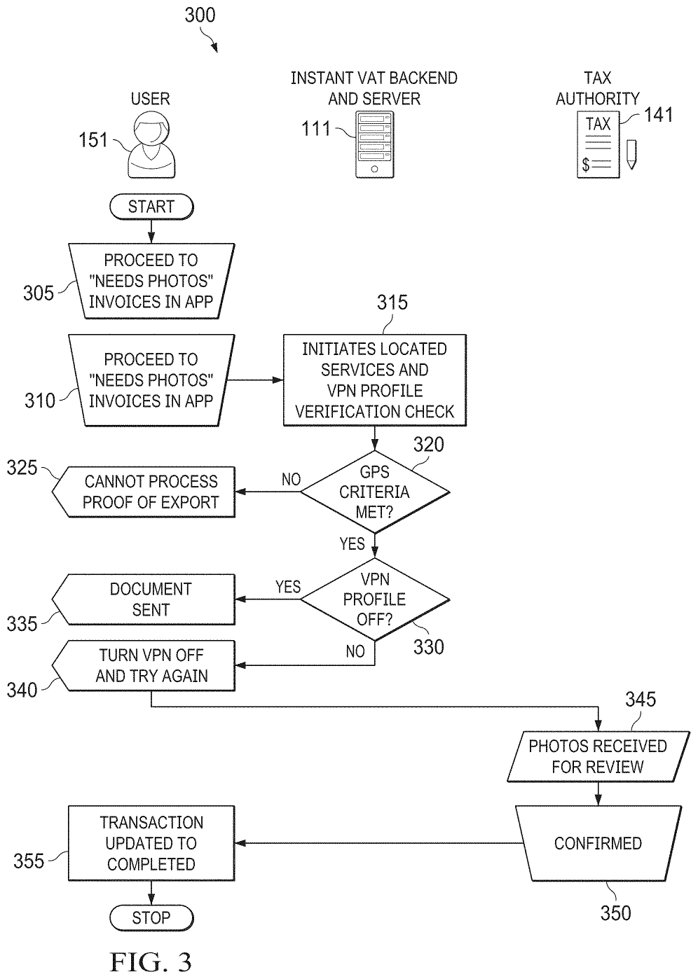

It should be understood that the retail database 175, the retail unit 170, and the retail computing device 165 facilitate operations at a retail location. Additionally, a tax authority rule compliance and follow-up system or “tax authority rule system” 115 may be executed by the backend server 111 for quality assurance purposes to validate/confirm the identity and/or transactions (e.g., proof-of-export processes) of the user 151 as required in certain embodiments. These aspects are further discussed in association with FIGS. 2 and 3. Furthermore, the administration server 121 may include a third-party server configured to run analytics of the operations executed by the system 100 for optimization purposes. The immigration system 171 may interface with validation systems of appropriate government agencies to confirm, among other things, that the user 151 is indeed a foreigner and that the user 151 has the appropriate documentation to be in the VAT-reimbursed jurisdiction. This described architecture herein provides analytics and validation techniques—both singly and collectively—that have not been possible in prior known systems and architectures.

The network 101 may include a plurality of networks. For instance, the network 101 may include any wired and/or wireless communication network that facilitates communication between the various components of the system 100. The network 101, in some instances, may include an Ethernet network, a cellular network, a local area network, the Internet, a wireless fidelity (Wi-Fi) network, a light fidelity (Li-Fi) network, a Bluetooth network, a radio frequency identification (RFID) network, a near-field communication (NFC) network, a laser-based network, and/or the like.

The servers discussed above (e.g., user device server 110, retailer wz server 120, retail server 130, rules server 135, one or more bank servers 131, government server or tax authority 141, etc.) as well as retail computing device 165 may include various elements of a computing environment such as one or more processing units, one or more memory units, one or more input/output (I/O) units, and one or more communication units.

The one or more processing units may control the operations of other components of the computing environment within which the aforementioned servers are implemented. For example, the one or more processing units may control operations of the one or more memory units, the one or more input/output (I/O) units, and the one or more communication units of the computing environment. Additionally, any actions described herein as being performed by a processor may be taken by the one or more processing units of a particular server within the system 100 in conjunction with one or more additional processors, units, subunits, elements, components, devices, and/or the like of the system 100.

In some embodiments, the one or more processing units may be implemented as one or more computer processing unit (CPU) chips and/or graphical processing unit (GPU) chips and may include a hardware device capable of executing computer instructions. The one or more processing units may execute instructions, codes, computer programs, and/or scripts that execute the workflows depicted in FIGS. 2-5. The instructions, codes, applications, computer programs, and/or scripts may be received from and/or stored in the one or more memory units associated with the servers within the system 100.

In some embodiments, the one or more processing units may include, among other elements, subunits such as a content management unit, a location determination unit, and a graphical processing unit (GPU). The content management unit may facilitate generation, modification, analysis, transmission, and/or presentation of content. Content may be file content or media content associated with event data within the system 100. In some instances, content includes device information, user interface data, images, text, themes, audio files, video files, documents, and/or the like. Additionally, the content management unit may control the audio-visual environment and/or appearance of application data during execution of various processes within the system 100. In some embodiments, the content management unit may interface with a third-party content server (e.g., via the immigration system 171) and/or a specific memory location for execution of its operations.

It should be further understood that although the elements of the entire system 100 include elements that may be provided by multiple third parties or governments, the generality of any patent claims issuing from this specification (or continuation applications stemming from this specification) shall not be limited by the description of this specification. A claimed system can comprise elements under the control of a single party or it can comprise elements under the control of multiple parties, depending upon the language of such claims.

The location determination unit of the one or more processors associated with specific servers within the system 100 may facilitate detection, generation, modification, analysis, transmission, and/or presentation of location information. Location information may include global positioning system (GPS) coordinates, an Internet Protocol (IP) address, a media access control (MAC) address, geolocation information, a port number, a server number, a proxy name and/or number, device information (e.g., a serial number), an address, a zip code, and/or the like. In some embodiments, the location determination unit may include various sensors, radar, and/or other specifically-purposed hardware elements for the location determination unit to acquire, measure, and/or otherwise transform location information associated with the user device 181 and or the retail system 161.

The GPU of the one or more processors associated with the servers shown in the system 100 may facilitate generation, modification, analysis, processing, transmission, and/or presentation of content described above, as well as any data (e.g., reimbursement data, transaction data, etc.) described herein. In some embodiments, the GPU may be utilized to render content for presentation on a computing device. The GPU may also include multiple GPUs and therefore may be configured to perform and/or execute multiple processes in parallel.

As previously mentioned, the servers shown in system 100 may be implemented within a computing environment having one or more memory units. The one or more memory units of the computing environment can be used for storing, recalling, receiving, transmitting, updating and/or accessing various files and/or data (e.g., event data) during operation of the system 100. In some embodiments, the one or more memory units may store instructions, code, applications, and/or data that may be executed by one or more processing units of the computing environment.

The one or more memory units may include various types of data storage media such as solid state storage media, hard disk storage media, virtual storage media, and/or the like. In some cases, the one or more memory units may include dedicated hardware elements such as hard drives and/or servers, as well as software elements such as cloud-based storage drives. In some implementations, the one or more memory units may be a random access memory (RAM) device, a dynamic random access memory (DRAM) device, a static random access memory (SRAM) device, flash memory, read only memory (ROM) device, and/or various forms of secondary storage. The RAM device may be used to store volatile data and/or to store instructions that may be executed by the one or more processing units of the computing environment. For example, the instructions stored by the RAM device may be a command, a current operating state of the computing environment, an intended operating state of computing environment, and/or the like. As a further example, data stored in the RAM device of the one or more memory units may include instructions related to various methods and/or functionalities described herein. The ROM device may be a non-volatile memory device that may have a smaller memory capacity than the memory capacity of a secondary storage. The ROM device may be used to store instructions and/or data that may be read during execution of computer instructions. In some embodiments, access to both the RAM device and ROM device may be faster to access than the secondary storage. Secondary storage may comprise one or more disk drives and/or tape drives and may be used for non-volatile storage of data or as an over-flow data storage device if the RAM device is not large enough to hold all working data. Secondary storage may be used to store applications that may be loaded into the RAM device when such applications are selected for execution.

The user device 181 may be a handheld computing device, a smart phone, a tablet, a laptop computer, a desktop computer, a personal digital assistant (PDA), a smart watch, a wearable device, a biometric device, an implanted device, a camera, a video recorder, an audio recorder, a touchscreen, a computer server, a virtual server, a virtual machine, and/or a video communication device. In some embodiments, the user device 181 may include a plurality of computing devices configured to communicate with one another and/or implement the techniques described herein. It is appreciated that the user device may include one or more components of the computing environment discussed above such as one or more processing units, one or more memory units, one or more I/O units, and one or more communication units.

The various databases (e.g., profiles database 105, retailer database 125, and retail database 175) may include one or more storage devices that store data, information, and instructions used by various elements of the system 100. The one or more storage devices provided in this disclosure may be non-volatile memory or similar permanent storage devices and media. For example, the one or more storage devices may include a hard disk drive, a floppy disk drive, a CD-ROM device, a DVD-ROM device, a DVD-RAM device, a DVD-RW device, a flash memory device, solid state media, or some other mass storage device known in the art for storing information on a more permanent basis. The various databases may also be hosted in the “cloud.”

Additional features implemented by the architecture 100 described herein provides, as discussed above, for the instant refund to a user's 151 digital wallet on their user device 181. Once such funds are transmitted to the user's digital wallet, it can in turn be transmitted to a user's credit card, bank card, bank account, or another user's digital wallet or associated “eTax” wallet, such as for example a user's family member, for them to spend on their same or another trip. Further, the funds on the digital wallet could be spent using the user device 181 through NFC technology or QR code or other communication technique. OCR technology embedded in the user device 181 or in the backend server 111 can be employed to capture receipt detail, which can help populate a database for transactions specific to the user or for the user and/or merchant communities as a whole.

Workflows

FIG. 2 illustrates a block diagram of an exemplary reimbursement workflow 200 using the system of FIG. 1. As seen in the figure, a user 151 may conclude 205 a purchase at a retail location following which a record associated with the purchase is made available to the user 151. According to some embodiments, the record may include a physical or digital receipt provided to the user 151. The user 151 may extract, using for example, the user device 181, relevant information from the record to initiate a real-time reimbursement process within a VAT-reimbursed jurisdiction. For example, relevant information may be retrieved from the record by inputting or scanning a bar code associated with the record to generate/open 210 a code (e.g., QR code, transaction ID, etc.) associated with the purchase. According to some implementations, the retail system 161 may calculate 215 an amount to be reimbursed to the user 151 based on the purchase at the retail location following which an API is initiated 220, at the backend server 111, to execute a reimbursement process that reimburses the user 151 for one or more tariffs levied on the purchase made at the retail location.

According to some embodiments, the backend server 111 may execute the reimbursement process and populate 225 the payment gateway server 140 with payment data associated with reimbursing the user 151. The payment gateway server 140 may transmit the payment data to the retail system 161 for further processing. Responsive to receiving the payment data, the retail system 161 may scan 230 the code generated by the user at step 210 and transmit confirmatory/validation data to the backend server 111 to initiate 235 a refund confirmation dialogue for the user 151. The refund communication dialogue may allow the user to communicate with other systems and modules of the system 100 other than the retail system 161.

The user 161 may confirm 240 a reimbursement amount associated with the reimbursement of the one or more tariffs that has been levied on the user's purchase and transmit, via the user device 181, transaction data including the reimbursement amount to be recorded 245 by for example, the database 175 of the retail system 161. The retail system 161 may, in some instances, transmit the recorded data to be recorded 250 by for example, the retailer database 125 of the backend server 111. The backend server 111 may then transmit payment data including the reimbursement amount to the one or more bank servers 131 to execute payment of the reimbursement amount to the user.

According to some embodiments, the one or more bank servers 131 may deduct 255 a credit line of the retailer of the retail system 161 and/or a credit line of a VAT agency by the reimbursement amount and then subsequently submit to the government server or tax authority 141 relevant updates to the transactions data associated with the user's purchase. The one or more bank servers 131 may directly transmit/credit the user's account or in some cases, transmit instructions to the government server or tax authority 141 to directly transmit payment information to the user 151 indicative of the reimbursements being payed to the user. The level of integration and streamlining of these various checks and coordination between constituent parties is far beyond currently known implementations, and the system may be instantly adaptable across all merchants and end users to implement updated taxing and/or security rules or regulations according to updates to the VAT rules process 135 (see FIG. 1).

According to some implementations, the payment information may include an indication of a credit/top up 265 to one or more financial accounts (e.g., bank account, digital wallet, etc.) of the user 151. This indication may automatically transmit a validation message to the one or more bank servers to validate/confirm 270 that the reimbursement amount is now available for use by the user. Once the one or more bank servers validate 270 that the reimbursement amount is available to the user, a countdown (e.g., proof-of-export) 275 may be initiated at the backend server 111 to confirm that indeed items associated with the purchase by the user would be taken out of the country. This is further discussed in conjunction with FIG. 3. At step 280, the government server or tax authority 141 may also log a fulfilment report indicative of the reimbursements being actually paid to the user 151. The government server or tax authority may also assign a pending status to logs associated with the proof-of-export until the user 151 actually provides the required proof as further discussed below.

FIG. 3 shows a block diagram of an exemplary proof-of-export workflow 300 based on the reimbursement workflow of FIG. 2. According to some implementations, a proof-of-export workflow allows one or more agencies (e.g., government agencies such as tax agencies, immigration services, internal revenue services, etc.) to verify that the user 151 is legitimately a foreigner and that the purchases made by the user 151 have been transported out of the VAT-reimbursed jurisdiction. A proof-of-export workflow may involve a user 151 leaving a VAT-reimbursed jurisdiction and subsequently taking photos in a jurisdiction other than the VAT-reimbursed jurisdiction of the purchases made from the VAT-reimbursed jurisdiction.

As can be seen in FIG. 3, the user 151 may launch an application on the user device 181 such that the application requests as input, photos or some other identification data associated with the purchases made from the VAT-reimbursed jurisdiction. As previously stated, the user 151 at this stage may have already claimed reimbursements associated with VAT levied on the purchases made and would have at this point in the workflow, left the VAT-reimbursed jurisdiction. The application from the user device 181 may, at step 310, transmit data associated with the input (e.g., photos, identifying information of the purchases, etc.) to the backend server 111 within the VAT-reimbursed jurisdiction. The backend server 111 may at this stage initiate 315 verification processes that determine, for example, the current location of the user 151.

As further security for the data transmitted, the backend server may, at 320, use geolocation data associated with the input received from the user device 181 to determine the location of the user 151 in order to confirm whether the purchases have indeed been taken out of the VAT-reimbursed jurisdiction. In other words, the backend server 111 can receive and process extracted geolocation information or other extracted metadata associated with the input that was transmitted from the user device 181 using the application to the backend server 111. By using this technique, along with requiring the product photographs to be submitted only by the user device camera in real-time and not, for example, from the user device's photo library, the backend server 111 can ensure compliance with the VAT export requirement.

With further reference to FIG. 3, if, for example, the backend server 111 determines that the geolocation data (e.g., GPS data of the input) does not indicate that the purchases are outside the VAT-reimbursed jurisdiction, the backend server 111 may transmit a notification to the user 151 via, for example, the user device 181. According to some implementations, the notification may include an indication 325 that the proof-of-export request cannot be processed thus alerting the user 151 that the proof-of-export requirement is still pending and unless addressed, could jeopardize chances of the user 151 enjoying benefits of future VAT-reimbursed consumption within the VAT-reimbursed jurisdiction in question. While GPS data associated with the input received by the backend server 111 has been used in this example, it is contemplated that other data such as IP address data, MAC address data, port number data, proxy name/proxy number data, and/or other geolocation data associated with the user device and tied to the input from the user device may also be used by the backend server 111 to execute the proof-of-export verification processes. The computer architectures described in this specification accordingly provide for an unprecedented level of verification and checking with regard to user compliance with VAT reimbursement protocols.

Turning back to FIG. 3, if the backend server 111 determines that the input from the user device 181 does indeed include geolocation data confirming that the purchases have been taken out of the VAT-reimbursed jurisdiction, the backend server 111 may transmit a notification to the user device 181. According to one implementation, the notification received by the user device 181 alerts the user 151 that the input (e.g., photos of the purchases taken outside the VAT-reimbursed jurisdiction) has also been sent 335 to the government server or tax authority 141 for review 345. According to some implementations, the backend server 111 may determine at step 330 that the user device 181 location is being incorrectly reported, such as because the user device is communicating through a Virtual Private Network (“VPN”). In that case, (at action 340) the backend server 111 may transmit a notification to the user 151 to turn “off” the VPN and try restart the proof-of-export process again.

When the government server or tax authority 141 confirms 350 the input transmitted at step 335, the government server or tax authority 141 may transmit an alert to the user device 181 indicating that the proof-of-export status associated with the purchases has been updated 355 from a pending status to a completed status. This in effect, confirms to the user that all requirements associated with the reimbursements has been met.

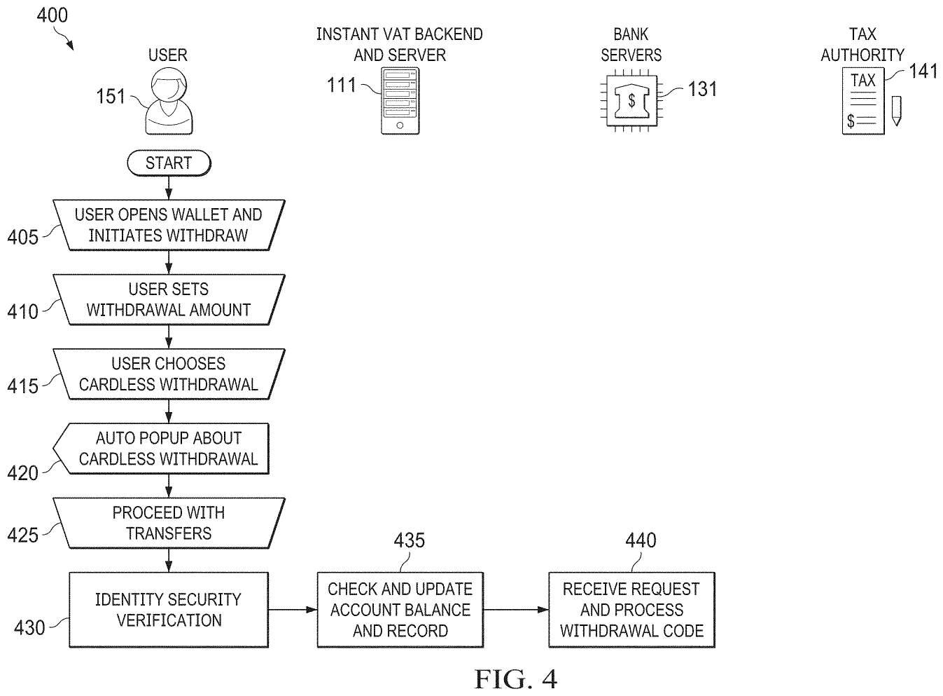

FIG. 4 illustrates a block diagram of an exemplary cardless withdrawal workflow based on reimbursements generated from the reimbursement workflow of FIG. 2. According to some implementations, a user may be alerted via an application on the user device 181 that a reimbursement associated with a purchase within a VAT-reimbursed jurisdiction is available to the user 151. In some cases, the alerting of the user via the application may happen in real-time (e.g., within about 2-30 seconds) or near-real-time (e.g., within about 2-5 minutes) after the user submits a reimbursement request to the retail system 161. According to some implementations, the user 151 may be able to use the reimbursement that has just been made available to make further purchases at the retailer associated with the retail system 161 or other retailers within the VAT-reimbursed jurisdiction.

According to some embodiments, the reimbursement is made available to the user via a digital wallet linked to the application on the user device 181. For example, the user may open 405 a digital wallet to initiate a withdrawal of the reimbursement. As part of the withdrawal process, the user may set 410 a withdrawal amount and select 415 a withdrawal method (e.g., cardless withdrawal). In some instances, the user device may display 420 information (e.g., auto pop-up about withdrawal method), using the application, about the withdrawal method before proceeding 425 with initiating moving/transferring the reimbursement for withdrawal by the user 151. In some embodiments, the user's identity may be verified 430 using the application. Once the user's identity is verified (e.g., using biometric information of the user 151, tokens sent to the user 151, etc.), the application may transmit the verification information to the backend server 111 to check 435 and update an account balance of the user and/or record information regarding the reimbursement being made to the user 151. This is possible because the backend server 111 may include an application that communicates with the application running on the user device 181 to seamlessly process reimbursement requests and record/log data resulting from processing the reimbursement request. The backend server 111 may transmit a request to the one or more bank servers 131 which receive 440 and process the withdrawal request for the reimbursement. In some cases, the backend server 111 transmits a withdrawal code in association with the withdrawal request to the one or more bank servers 131.

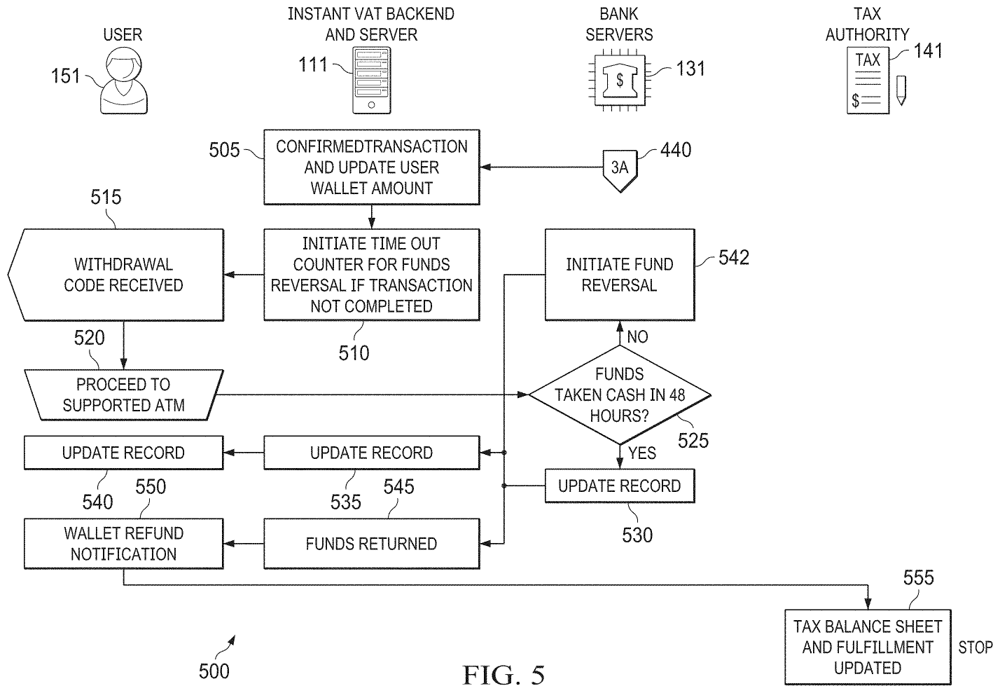

As seen in FIG. 5, the one or more bank servers 131 may transmit a confirmatory notification to the backend server 111. According to some implementations, the confirmatory notification may provide an indication 505 that the request to process the withdrawal request for the reimbursement has been received and is being executed by the one or more bank servers 131. The backend server 111 may initiate 510 a counter (e.g., timeout counter) for a fund-reversal process if the reimbursement request is not processed and the reimbursement is not released to the user within a certain timeframe (e.g., 2-30 seconds, 2-5 minutes, etc.). According to some implementations, the user 151 may receive 515 a withdrawal code from the backend server 111 to proceed 520 to a supported reimbursement dispenser such as a supported ATM machine. The reimbursement dispenser may, in some embodiments, include one or more cash retrieval systems and/or cash retrieval processes available via the retail system 161.

The one or more bank servers 131 may determine 525 whether the user 151 has obtained the reimbursement using the code within a set timeframe (e.g., 24 hours, 48 hours, etc.) after receiving the code. Responsive to this determination, the one or more bank servers 131 may update 530 records associated with the reimbursement and transmit an update notification to the backend server 111 to similarly update 535 its records. Similarly, the backend server 111 may also transmit an update notification 540 to the user 151 via the user device 181 regarding the updates made on the backend server and/or the one or more bank servers 131.

According to some implementations, if the one or more bank servers 131 determine 525 that the reimbursements have not been released to the user within a certain timeframe (e.g., 24 hours, 48 hours, etc.), the one or more bank servers 131 may initiate 542 a fund-reversal process and transmit a notification to the backend server 111 indicative of the reimbursements being returned to appropriate entities (e.g., tax administration service of the VAT-reimbursed jurisdiction, internal revenue service of the VAT-reimbursed jurisdiction, etc.). The backend server may in turn transmit a notification to the user device 181 which may be displayed 550 to the user regarding the reimbursements being returned to the appropriate entities. Additionally, the user device 181 may also transmit a notification to the government server or tax authority 141 to update 555 records associated with the reimbursement with information regarding the reimbursements being returned.

It may be appreciated that the workflows of FIGS. 2-5 may be implemented by a single application distributed over various components of the system 100, and/or multiple applications distributed over the various components of the system 100. It may also be appreciated that although the terms first, second, etc., may be used herein to describe various elements/components, these elements should not be limited by these terms. These terms are used to distinguish one element from another.

The terminology used in the description herein is for the purpose of describing particular embodiments and is not intended to be limiting. As used in the description of the subject matter provided, the singular forms “a,” “an” and “the” are intended to include the plural forms as well, unless the context clearly indicates otherwise. It is further appreciated that the term “and/or” as used herein refers to and encompasses any possible combination of one or more of the associated listed items. Additionally, the terms “includes,” “including,” “comprises” and/or “comprising,” when used in this specification, may specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context.

The computing environments, methods, processing procedures, techniques and workflows disclosed herein provide a more efficient and/or effective ways for reimbursements associated with VAT-reimbursed consumption within a VAT-reimbursed jurisdiction. Embodiments are directed to new and specialized processing applications and/or apparatuses and methods of using the same. Operations according to the present disclosure implicate a new processing approach (e.g., hardware, special purpose processors, and specially programmed general purpose processors) because such analyses and real-time information communications are too complex and cannot be realistically performed by a person.

The systems and methods described above provide important improvements to reimbursing foreigners with VAT levied on purchases made within a VAT-reimbursed jurisdiction. The systems and methods described cannot be manually performed in any useful sense. Simplified systems may be used for illustrative purposes but it will be appreciated that the disclosure extends to complex systems with many constraints thereby necessitating the new hardware-based processing system described herein. The principles disclosed herein may be combined with a computing system to provide an integrated and practical application to achieve the workflows described in the figures provided in this disclosure.

The above description has been written with reference to specific embodiments. However, the illustrative discussions above are not intended to be exhaustive; neither do they limit this disclosure to the precise forms presented. Many modifications and variations are possible in view of the above teachings. The embodiments were chosen and described in order to explain the principles of the present disclosure and its practical applications, to thereby enable others skilled in the art to utilize the principles described and various embodiments with various modifications as suited to the particular use contemplated.

What is claimed is:

1. A computer system for single and consolidated real-time processing of event data received from a plurality of distributed networks and for communicating with multiple user devices in connection with the processing of that event data in accordance with an adaptive processing rules schema, the system comprising:
a) a distributed system interface operable to receive the event data from the plurality of distributed networks in the form of event data transactions, wherein the event data transactions are subject to VAT taxes that may be refundable in accordance with taxing rules in a jurisdiction;
b) a rules schema database, the rules schema database containing tax models applicable to various event data transactions;
c) an event data processor in communication with the distributed system interface and the rules schema database, the event data processor operable to receive the event data transactions and apply the tax models in the rules schema database to the received event data transactions;
d) a payment gateway processor in communication with the event data processor, the payment gateway processor in communication with a plurality of payment systems, the payment gateway processor operable to direct electronic transactions to occur in responding to the processing of the event data based at least in part on rules stored in the rules schema database in communication with the event data processor; and
e) a compliance system in communication with a user device and the rules schema database in communication with the event data processor, the data compliance system operable to communicate electronically with the user device to determine whether all conditions for determining at least one of whether to approve the payment gateway processor to direct an electronic transaction to occur and whether to determine that subsequent conditions to satisfy a previously directed electronic transaction have been fulfilled.

2. The computer system of claim 1 wherein the compliance system in communication with a user device uses system information characteristic of the user device to determine the user device's location and accordingly the confirmation of the at least one of the approval of the electronic transaction occurring and the determining that the subsequent conditions to satisfy a previously directed electronic transactions had occurred.

3. The computer system of claim 2 wherein the initially directed electronic transaction is a VAT tax refund.

4. The computer system of claim 3 wherein the compliance system in communication with a user device uses system information characteristic of the user device to determine the user device's location along with photographs taken by a camera associated with the user device to confirm that the user has satisfied subsequent conditions relating to an initially directed VAT tax refund.

5. The computer system of claim 4 wherein the characteristics of the user device include at least one characteristic from the group consisting of its present GPS coordinates, a communication IP address, cell phone geolocation information, and a connected IP server address.

6. The computer system of claim 1 wherein the event data received from the plurality of distributed networks includes metadata associated with the event data transactions, where the metadata includes information indicative of the locations of the event data transactions.

7. The computer system of claim 6 wherein the metadata associated with the event data transactions includes location data for the retail system on which the event data transactions are being initiated.

8. The computer system of claim 7 wherein the location data for the retail system includes at least one type of metadata from the group consisting of GPS coordinates, a retailer name, a retailer store number, retailer authentication credentials/protocols, a retailer ID number, a communication IP address, cell phone geolocation information, and a connected IP server address.

9. The computer system of claim 8 wherein the at least one type of metadata is transmitted from the retail system and is determined by the retail system by communication with a user device.

10. The computer system of claim 8 wherein the at least one type of metadata is transmitted from the retail system and is metadata that is independent of the user device.

11. The computer system of claim 1 and further comprising an immigration data processor in communication with a third-party content server for determining the immigration status of a user associated with an event data transaction, whereby the event data processor determines if the user is eligible for a VAT refund.
